(19) United States
(12) Patent Application Publication
(10) Pub. No.: US 2019/0147537 A1
(43) Pub. Date: May 16, 2019

(54) A PARETO-BASED GENETIC ALGORITHM FOR A DYNAMIC PORTFOLIO MANAGEMENT

(71) Applicant: WORLDLINE, BEZONS (FR)

(72) Inventors: Yacine KESSACI, Lille (FR); Frédéric OBLE, Lyon (FR)

(21) Appl. No.: 16/308,817

(22) PCT Filed: Jun. 13, 2016
(86) PCT No.: PCT/IB2016/001016

§ 371 Date: Dec. 10, 2018

(51) Int. Cl. G06Q 40/06; G06N 3/12; G06F 17/11

(52) U.S. Cl. CPC G06Q 40/06; G06F 17/11; G06N 3/126

(57) ABSTRACT

It is proposed a computing method, providing a new multi-objective Continuous Genetic Algorithm (GA) for Portfolio Management. First, it retrieves both the historical prices of the dealt with stocks and the specifications of the user. Second, it computes the return and risk of each stock. The third step is the processing of a specific GA to find the portfolios with the best tradeoff between return and risk. The GA uses a crossover and a mutation operator to improve the obtained solutions quality. After a fixed number of generations, a set of Pareto optimum solutions is stored in a Pareto archive. Next, it selects one solution among the set of proposed Pareto. This selection process is done according to the user's specifications and profile. This solution will be the portfolio determining the strategy of investment until the next processing cycle of the next period of time.

### FIELD OF THE INVENTION

The present invention refers to a computing method for a financial portfolio management.

### BACKGROUND OF THE INVENTION

The idea of managing a Portfolio of assets started to be developed since the advent of the Modern Portfolio Theory (MPT). Presented by Markovitz in Portfolio Selection: efficient diversification of investments, 1959, this theory formalizes the efficiency of a portfolio with two main parameters: its risk and its return. In his work, Markovitz proposes to express these two parameters with a mean-variance (MV) theorem respectively for the return and the risk to express the tradeoff that a user faces when expecting returns from his portfolio. Indeed, the most returns a portfolio might have, the highest risky it might be (and vice versa). Markovitz's theory inspired many subsequent works, which contributed to make practice progress over different applications.

Therefore, in the 1960s, Sharpe, Lintner and Mossin respectively in Sharpe, Capital asset prices: a theory of market equilibrium under conditions of risk, 1964, and in Lintner, Security prices, risk, and maximal gains, from diversification, 1965, and in Mossin, Equilibrium in a capital asset market, 1966, developed a portfolio model combining the Markowitz assets with an additional asset, with a defined future return, called “risk-free asset”. Latane, in Criteria for choice among risky ventures, 1959, introduces the concept of multi-period portfolio by computing each time a unique portfolio for each period based on a geometric return model. Fama, in Common risk factors in the returns on stocks and bonds, 1993, proposes a modeling for estimating the portfolio return based on three factors called betas. Meanwhile, Merton, in life time portfolio selection under uncertainty: the continuous case-time case, 1969, modeled the behavior of the market using Brownian motion. Besides, the classical mean-variance theory was criticized because of its lack of realism. Indeed, it makes some assumptions that let the model disconnected from the reality of the market. As an answer to these criticisms, several improvements were proposed over Markowitz's classical MPT model by adding realistic constraints such as: limits on the quantity and cardinality of the portfolio's assets, the integration of the fees of the transaction orders, etc. Some other works focused on how tracking the market variation, while some others improved the way how the risk and return parameters are computed.

Hence, new measures, such as value-at-risk (VaR) or conditional value-at-risk (CVaR), were proposed to estimate the risk, while others were developed aiming at estimating the return of the portfolios. Complexity is the common noticeable fact brought by the integration of the realistic market constraints. This led to the incapacity of solving the portfolio problem with exact methods within a reasonable schedule of time.

Therefore, different heuristics approaches were developed. Agarwal, in Algorithms for portfolio management based on the newton method, 2006, proposes a tracking method by following the portfolio providing the best results compared to the market (follow-the-leader). However, unlike a simple follow the leader strategy which is based on a simple gradient descent method, the proposed algorithm takes advantage from the second derivative of the functions (Newton method) to reduce the difference with the live market variation (regret) and to fit as much as possible the optimal solution.

Bolgle, in the implication of style analysis for mutual fund performance, 1998, showed that low-cost passively managed index funds have the best delivery regarding the tradeoff risk return.

Oh, in Using genetic algorithm to support portfolio optimization for index fund management, 2005, proposes a genetic algorithm for optimizing a portfolio of index funds. The proposed process is based on fundamental variables (standard error, beta parameters, average trading amount and average market capitalization) to select the stocks for the index fund, and relies on the genetic algorithm processing to find the weight of each stock. A lot of evolutionary heuristics may also be found in the literature.

As it is mainly modeled as a multi-objective problem, the portfolio management problem is adapted to such algorithms.

Cesarone, in Efficient algorithm for mean-variance portfolio optimization with hard real-world constraints, 2009, proposes a mixed integer quadratic model over a problem called Limited Asset Markowitz (LAM) with the cardinality and quantity constraints and shows that this model outperforms the classical Markowitz portfolio.

Anagnostopoulos et al, in Multiobjective evolutionary algorithms for complex portfolio optimization problems, 2009, evaluates different multi-objective evolutionary algorithms (NSGA-II, PESA and SPEA-II) for solving complex portfolio optimization problems by comparing them to exact methods using epsilon and hyper volume indicators. The authors conclude that most algorithms perform well in terms of closeness to the optimal Pareto front, while offering flexibility over the model (i.e. adding constraints, changing the objective functions).

Anagnostopoulos, in A portfolio optimization model with three objectives and discrete variables, 2010, addresses a three-objective portfolio management problem (risk, return and number of securities in the portfolio) with quantity and class constraints. Anagnostopoulos models said problem as a mixed-integer multi-objective problem solved with a NSGA-II, PESA and SPEA-II evolutionary algorithms.

Golmakani, in Constrained portfolio selection using particle swarm optimization, 2011, proposes an optimization method for extended mean-variance portfolio with a set of constraints (bounds on holdings, cardinality . . . ) based on a particle swarm optimization (PSO) approach.

Deb et al in Deb, Bi-objective portfolio optimization using a customized hybrid NSGA-II procedure, 2011 propose a customized NSGA-II genetic algorithm to deal with a bi-objective (risk-return) portfolio optimization to face non-conventional situations for classical quadratic programming approaches.

Finally, Metaxiotis, in Multiobjective evolutionary algorithms for portfolio management, 2012, shows that future research aims at the development of interactive Multi-Objective Evolutionary Algorithms (MOEA) that embed an efficient decision making mechanism to provide the best results.

There is a need for tackling the aforementioned challenges with an approach that aims at aggregating different strategies of portfolio management with a multi-objective genetic algorithm based approach (CGA-PM).

The proposed algorithm uses a real-value genotype to cope with the complexity of the market constraints; it integrates a periodic dynamic mechanism of portfolio evolution, a cardinality constraint to involve the idea of index fund trackers (i.e. dealing with a sub set of stocks from the stock exchange market), a quantity limit over the investment to fit the reality of the market, a decision aid on the portfolio selection mechanism and an integration of the order fees.

### SUMMARY OF THE INVENTION

It is proposed a computing method for a financial portfolio management, the portfolio containing different amounts of different stocks (assets), belonging to a user, characterized in which it integrates a specific mechanism for mutation and crossover operators in genetic algorithm and comprising the steps of:
representing the portfolio as a table of cells, wherein each cell contains a value of index identifying the stock and a value of weight representing the amount of investment for the concerned stock,
retrieving stock prices and user's specifications, wherein the users specifications correspond to the parameters:
   a cardinality value which is the maximum number of stocks to hold in the portfolio,
   a quantity value which is the maximum amount of investment allowed to be done on risky stocks,
   a quantityRFA value which is the maximum amount of investment allowed to be done on a risk-free asset,
   a fees value which is the fees paid by the user,
   a period value which is the period after which the portfolio can evolve according to stock market changes.
computing the risk and the expected return of each stock of the portfolio,
initializing a population of a plurality of portfolios, this population being the initial solutions of the portfolio according to the parameters,
applying a fitness function which consists in computing a minimized Risk value and a maximized Return value as follows:
   Maximized Return=Max(Σᵢ^{N} wᵢ·Eᵣ_{ᵢ}) where Eᵣ_{ᵢ} is the expected return value for a stock i in the portfolio, wᵢ the weight for a stock i, and N the number of stocks in the portfolio,
   Minimized Risk=Min(Σⱼ^{N}((Σᵢ^{N} wᵢ·CovMatrix_{i,j})·wⱼ)), where N is the total number of stocks, wᵢ and wⱼ are the weight values (invest values) of the stock i and j in the portfolio, CovMatrix_{i,j} is the N×N matrix of variance and covariance values of the N dealt with stocks,
temporary storing in an archive the portfolios which have a Return superior or equal to the current highest Maximized Return and a Risk inferior or equal to the current lowest Minimized Risk,
calculating a crowding distance, wherein the crowding distance is a metric defined as the circumference of a rectangle defined by the left and the right portfolios neighbors of the portfolio solution or by its unique side neighbor and the infinity in case of a single neighbor, in the representation of the Return as a function of the Risk,
updating the archive by maintaining only the non-dominated portfolios with the largest diversity (large crowding distance), non-dominated referring to a portfolio that is not dominated in both objectives Risk and Return meaning that no portfolios in the archive has both superior Return and inferior Risk,
selecting two portfolios parent1 and parent2, according to the roulette selection method wherein the selected portfolios parent 1 and parent 2 have the highest probabilities to be selected, wherein the probability pᵢ of a portfolio i to be selected is expressed as

$${p}_{i} = \frac{{f}_{i}}{{\sum }_{j = 1}^{N} {f}_{j}}$$

wherein fᵢ is the fitness value of the portfolio i, Σⱼ₌₁^{N}fⱼ is the sum of the fitness values of all portfolios of the population, N is the number of individuals (portfolios) in the population,
applying a crossover operator on parent1 and parent2 or a mutation operator to parent1, and generating offspring1 and offspring2 just one offspring called offspring1, wherein:
   the mutation operator chooses randomly two integers i and j such that 1≤i<j≤N, where N is the total number of stocks, and swaps the weights of the concerned stocks i and j,
   the crossover operator:
      considers a first and a second parent portfolio respectively s₁ and s₂,
      randomly selects a β value such that 0≤β≤1,
      randomly selects two integers i and j such that 0≤i<j≤n, if generating s′₁ and n≤i<j≤N if generating s′₂ where n is the number of stocks without the risk-free assets and N is the total number of assets.
      copies in s all values of s₁ located between i and j, where s is temporary portfolio,
      applies the formula s′₁=β·s₁+(1−β)·s₂ between each couple of values of s₁ and s₂ storing the results in s′₁, where s′₁ is the offspring portfolio.
      copies all the values of s to the indexes of s′₁ between i and j.
      generating offspring s′₁,
      generating a second offspring s′₂ by considering s₂ as the first parent and s₁ as the second parent, and applying the same previous calculations,
updating the set of portfolios, according to both elitism and crowding distance, by taking each time the portfolios with the highest fitness (elitism) while looking for the highest crowding distance to keep diversity,
storing the solutions in a Pareto archive, comprising the steps of:
   checking if the new input portfolio is not dominated by any portfolio in the archive,
   adding the new portfolio to the archive if there is no dominating portfolio,
   keeping the one with the highest crowding distance if two portfolios are equal,
   deleting any dominated portfolio from the archive,
   returning a set of non-dominated portfolios,
selecting one portfolio in the archive according to a chosen policy,
returning this portfolio to the user,
initiating a new cycle comprising the steps from the retrieving stock prices and user's specifications to this one, according to a period of time called period.

The initialized population comprises at least 100 portfolios in a preferred parametrization.

The encoding step has a step of assigning a value 0 to the weights of the stocks exceeding the cardinality limit.

The initializing step comprises the steps of:
generating random weight values according to cardinality and quantity parameters,
checking at each step of the creation of a new portfolios via the crossover or the mutation operator, the following constraints in the portfolios:
   the sum of the weights of all the stocks of each portfolio must be equal to one,
   the weight of a risky stock must be inferior or equal to quantity value,
   the weight of a risk-free asset must be inferior or equal to quantityRFA value,
   the cardinality limit,
fixing the portfolios that do not respect these constraints using
   an offensive mechanism which consists in preventing, during the crossover, the event in which there is more stocks with a weight superior to zero than the cardinality value,
   or a defensive mechanism which consists in equilibrating the weights of the assets in the case they exceed the quality limit while maintaining the sum of all the weights to one.

The random weight values generating step consists in:
generating values, higher than 0 and smaller than quantity, the number of generated values being equal to the cardinality value,
and randomly assigning those values to the different stocks.

The determination of the expected return of a stock comprises the steps of:
retrieving a matrix of the historical returns of the stocks,
computing, from the matrix of historical returns, a variance covariance matrix of all the stocks,
retrieving the values of the Moving Average Convergence Divergence Method (MACD) and the Average Index Indicator (ADX) indicator, which are two stock market indicators,
computing the level of agreement following FIG. 1 between the values that both ADX and MACD have over the studied period by:
   making the product of the absolute values of both ADX and MACD
assigning the value of this level of agreement to the absolute value of the expected return,
assigning a negative sign to the expected return if both MACD and ADX indicators agree on a decreasing trend and positive otherwise.

### BRIEF DESCRIPTION OF THE DRAWINGS

FIG. 1 presents a table of an example computation of expected stock's returns.

FIG. 2 is an illustration of the problem encoding, according to an example.

FIG. 3 is a diagram of the flowchart of the CGA-PM algorithm.

FIG. 4 is an illustration of crowding distance determination, according to an example of population.

### DETAILED DESCRIPTION

The proposed system model is composed of two tiers: on one side a broker and in the other side the end user. The approach of this invention is presented as an offer proposed by the broker to the users that want to manage their stock portfolio. The end user has a full access to the parameters of the approach such as the number of stocks that he wants to deal with (cardinality) the maximum quantity that he wants to invest in each stock (quantity), the maximum amount that he can hold safe by investing in the risk-free asset, the brokerage subscription contract including the fees that he has to pay for the orders and the period of time after which he wants the process of the update of his portfolio according the stock exchange evolution.

Thus, each time, this approach offers different portfolios according to the user wishes. The fees are paid by the user to the broker based on the amount of orders that the portfolio generates (purchases or sales). In other word, each time there is a change in the portfolio the user pays fees for these changes.

A portfolio represents a set of assets (stocks) owned by a person at a certain moment. This portfolio summarizes information including the type of assets and the quantity of investment that the portfolio holder has on each type of asset.

The objective of the owner is to have a portfolio that is composed with the best assets and the best investment rates at each moment.

The portfolio can be modeled as a vector of values. Besides, and as previously said, there are some similitudes with a MPT problem inspired by the Markowitz formulation. However, the differences between the model of this invention and the classical Markowitz problem will appear clearly in the following description. Indeed, the problem is integrating several constraints in order to fit with the financial and trading constraints. Hence, the quantity constraint offers more safety and forces diversity in the owned stocks which helps to reassure the user. The cardinality plays a similar role by bounding the number of managed stocks and by giving the control to the portfolio holder on the size of his portfolio. According to this invention, the problem is addressed using a heuristic approach (genetic algorithm).

The risk can be expressed using one of the most famous following techniques: variance, Value at Risk (VaR) and Conditional Value at Risk (CVaR). Regarding the expression of the return, one can site the Capital Asset Pricing Model (CAPM), the charting (Bollinger bands, RSI . . . ) or other extrapolation techniques. According to this invention, the risk model relies on the variance method. Hence, a variance covariance matrix of all the stocks that the portfolio may deal with is computed. The advantage of this method is that it offers a global view of the stocks' fluctuation since based on a long history period. Moreover, it provides information regarding the impact that the evolution of each stock has on the other.

The covariance matrix is computed from the matrix of the historical returns of the stocks. Regarding the return, the model is based on two stock market technical indicators. Thus, the expected returns of each stock are computed automatically according to the prevision offered by the interpretation of the MACD and the ADX indicators.

MACD stands for the Moving Average Convergence Divergence method. It uses two components to provide results on the trend of each stock. The first component is the result obtained from the difference between two exponential moving averages over different periods of the stock price history. The second component uses the result of the first component as an input to compute an exponential moving average over it for a shorter period of time than the ones used to compute the first component. The interpretation of the variation of the stock's returns depends on the behavior of the results of the first and the second components of the MACD method. Indeed, drawn as curves, both components of the MACD technique provide trends based on the distance between the curves and/or their crossing.

ADX (Average Directional Index) is based on two indexes accumulating respectively the increases and the decreases of the history of stock prices. It takes the form of a value between 0 and 100 that depicts the strength of the current trend of the stock. Thus, the higher value or most significant growth phase is ADX, the stronger will be the current trend of the stock. According to this invention, the expected return of each stock is related to the result of the combination of the results of both MACD and ADX. The strength of the expected return value depends on the level of agreement that both ADX and MACD have over the studied period.

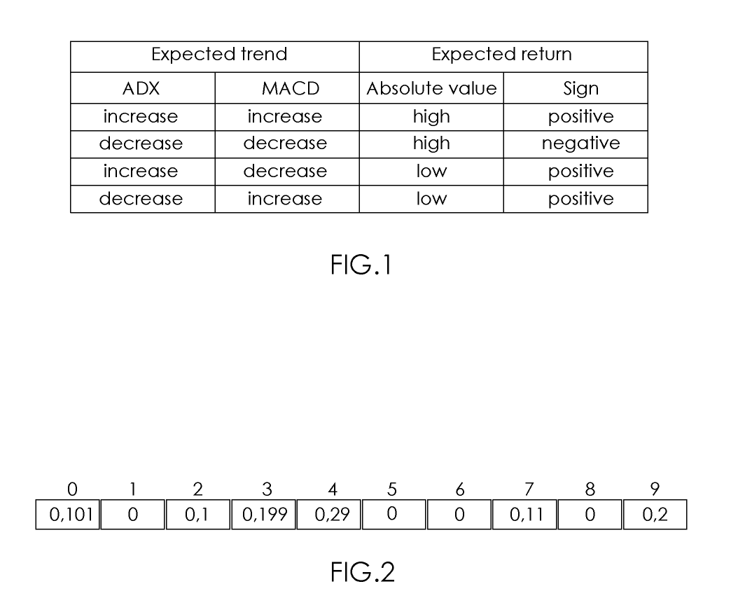

Indeed, the higher confidences are both indicators, the higher value will be assigned to the absolute expected return of the stock. Conversely, if both methods do not agree on the expectations then the value of the expected return will be low. The sign of the expected return value of each stock is negative if both indicators agree on a decreasing trend and positive otherwise, as illustrated in FIG. 1.

The problem is composed of both a combinatorial optimization problem and continuous optimization problem. Indeed, the objective of finding the most efficient portfolio—according to both the user wishes and the market fluctuations—goes through finding the most interesting combination of stocks to be hold (combinatorial problem) and the best weight (amount of investment) for each one of these stocks (continuous problem). Besides, the efficiency of the computed portfolios is based on the variation of the price of each amount of stocks hold in the selected portfolio for a defined period. In order to find the most appropriate decisions in the composition of the portfolio, our algorithm addresses all the aforementioned constraints while integrating the different information of the risk and the return of each stock.

When a user wants to access to the service provided by our algorithm, he provides his wishes in form of a five parameters request. The first parameter is the maximum number of stocks that the user wants to hold in his portfolio cardinality, the second is the maximum amount of investment allowed to be done on risky assets (stocks) quantity, the third is the maximum investment on the risk-free asset quantityRFA, the forth is the fees paid by the user per order depending on the type of brokering subscription contract fees and the last one is the period after which the portfolio can evolve according to the stock market changes period.

The present invention refers to a Pareto multi-objective genetic algorithm based on NSGA-II. To understand the NSGA-II the reader can refer to Deb, a fast and elitist multiobjective genetic algorithm: NSGA-II, 2002. The objective functions, also called fitness function, of the approach, aim at minimize the portfolio risk (Risk) and maximize the portfolio return (Return) while respecting the different cited constraints. The model is formulated in the following equations (1) to (6).

Minimizing Risk=Min(Σⱼ^{N}((Σᵢ^{N} wᵢ·CovMatrix_{i,j})·wⱼ)) (1)

Where N is the total number of stocks, wᵢ and wⱼ are the weight values (invest values) of the stock i and j in the portfolio. CovMatrix_{i,j} is the N×N matrix of variance and covariance values of the N dealt with stocks. The two different indexes i and j for the weights w are due to product between the vector of weights and the matrix of variance and covariance which requires two steps (the first step with wᵢ and the second with wⱼ to obtain the risk value of the portfolio Risk.

Maximizing Return=Max(Σᵢ^{N} wᵢ·Eᵣ_{ᵢ}) (2)

Where Eᵣ_{ᵢ} is the expected return value for a stock i in the portfolio and Return is the return value of the portfolio.

⇄ᵢ^{N} wᵢ=1 (3)

∀ i ∈ N−{1}: wᵢ≤quantity (4)

Where N−{1} is a set N of all stocks without the risk-free asset.

if i=max(N): wᵢ≤quantityRFA (5)

Where max(N) is the index value of the risk-free asset.

∀ i ∈ N−{1}: Card(wᵢ≠0)=Cardinality (6)

Where Card(wᵢ≠0) is the number of weights having a value different from 0. The weights equal to 0 are the weights of the non-selected stocks. Therefore, the number of weights different from 0 represents the number of stocks having investment on them (selected stocks).

One step of the present invention consists in encoding a portfolio as illustrated in FIG. 2. Dealing with a genetic algorithm, each portfolio represents a potential solution in the process of the CGA-PM (Continuous Genetic Algorithm for Portfolio Management) approach according to the present invention. Indeed, FIG. 2 represents one possible portfolio. In the proposed example, the indexes of the table depict the stocks (assets) that are managed in the portfolio, and the value in each cell identifies the weight assigned to the stock in the portfolio. In other words, the weight of each stock represents the amount of investment that this stock obtains among the total investment of the portfolio. Therefore, the first cell (index 0) represents the first stock of the pool that is handled by the genetic algorithm. In this case, the stock has an amount of investment of 0.101 over a total of 1. The second stock has a weight of 0 and so on. A weight of 0 means that the stock does not have any investment on it, this means that it is not selected by the portfolio. This encoding method informs about the total number of stocks managed by the portfolio, the number of the selected ones and their ID (index). In the example presented in FIG. 2, the portfolio manages 10 stocks with only 6 active stocks having an investment on them. This encoding method allows respecting the cardinality constraint by assigning the value 0 to the stocks exceeding the cardinality limit. This is done without shrinking the size of the solution exploration space of the algorithm since using a genotype including all the possible stocks.

The genetic algorithm according to the present invention has a step of population initialization which corresponds to the generation of the initial solution. This initialization is done in two steps. The first step generates random values by respecting both cardinality and quantity constraints. To do so, the process generates a number of values, bigger than 0 and smaller than quantity in a number of values being equal to cardinality value. Those values are afterward shuffled to be randomly assigned to the different stocks composing the portfolio. The second step consists of checking and fixing the solutions that do not respect the remaining constraints such as the one in Equation 3. The aim of these two steps is to eliminate the unfeasible solutions in order to maximize the chances of the following steps of the genetic algorithm to reach the best portfolio regarding the addressed objectives (Return, Risk).

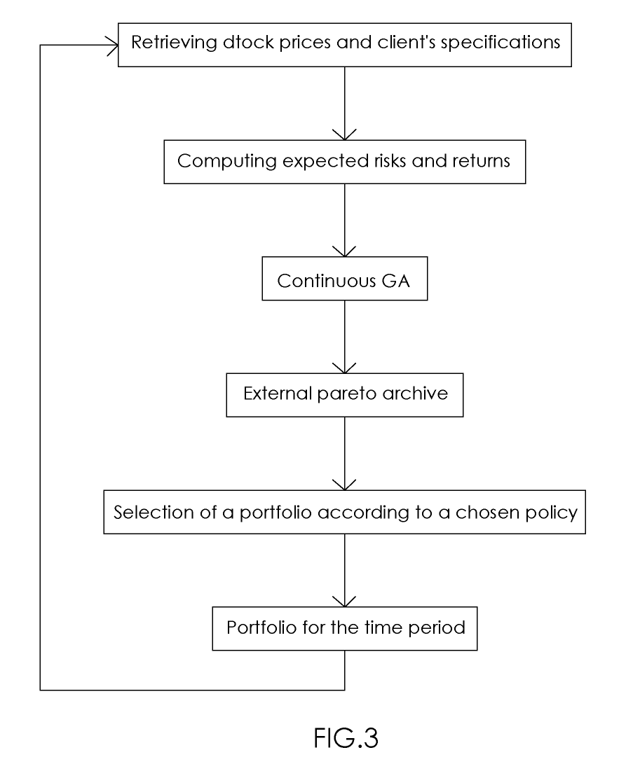

After the problem encoding and population initialization steps, a CGA-PM algorithm is executed. This CGA-PM has seven scheduled steps illustrated in FIG. 3. The first step of the CGA-PM is to retrieve both the historical prices of the dealt with stocks and the specifications of the user (constraints).

Starting from this information, the second step computes the expected return and risk of each stock according to the risk and return model previously presented. The population initialization represents the initial phase of the continuous genetic algorithm (third step of the CGA-PM, continuous GA in FIG. 3). The set of the retrieved initial solutions (portfolios) are processed by the genetic algorithm to find the best portfolios.

To do so, it first processes the fitness function previously presented.

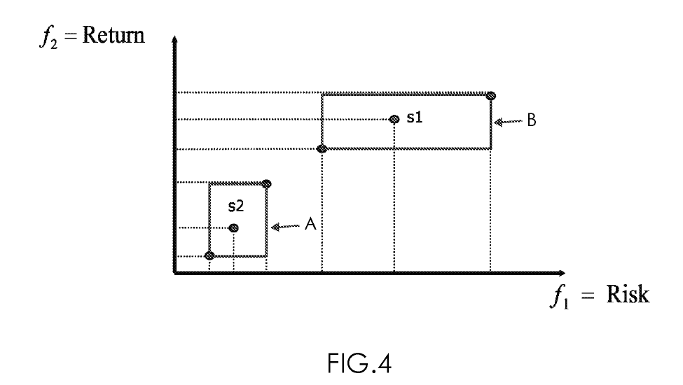

It calculates a crowding distance, wherein the crowding distance is a metric defined as the circumference of a rectangle defined by the left and the right portfolios neighbors of the portfolio solution or by its unique side neighbor and the infinity in case of a single neighbor. An example of crowding distance is illustrated in FIG. 4 representing the Return of a portfolio as a function of its Risk. The crowding distance is a measure of how close a portfolio is to its neighbors. Large crowding distance will result in better diversity in the population. In FIG. 4, there are illustrated two crowding distances (circumference of a rectangle) by arrows A and B for portfolios s2 and s1 respectively.

Next, it temporary stores in an archive the solutions of portfolios which have a Return superior or equal to Maximized Return and a Risk inferior or equal to Minimized Risk and have the highest diversity (crowding distance).

It updates the archive by maintaining only the non-dominated portfolio and the ones with highest diversity, non-dominated referring to a portfolio that is not dominated in both objectives Risk and Return meaning that no portfolios in the archive has both superior Return and inferior Risk.

These portfolios are the ones with the best tradeoff between the Return and the Risk.

Then it selects two portfolios parent1 and parent2 or just one portfolio parent1, according to the roulette selection method. This method consists in selecting two portfolios parent1 and parent2 having the highest probabilities to be selected, wherein the probability pᵢ of a portfolio i to be selected is expressed as

$${p}_{i} = \frac{{f}_{i}}{{\sum }_{j = 1}^{N} {f}_{j}}$$

wherein fᵢ is the fitness value of the portfolio i, Σⱼ₌₁^{N}fⱼ is the sum of the fitness values of all portfolios of the population, N is the number of individuals (portfolios) in the population,

The genetic algorithm uses variation operators such as the crossover and the mutation in order to evolve and improve the quality of the obtained solutions. After a fixed number of generations we obtain a set of Pareto optimum solutions stored in a final Pareto archive. The role of the next step is to select one solution among the set of proposed Pareto solutions in the final archive as being the portfolio provided to the user. This selection process is done according to the user's specifications and profile. This solution will be the portfolio determining the strategy of investment until the next processing cycle of the next period of time. As previously said, the period of time between each portfolio change noted period, is also a parameter specified by the user.

The evolutionary core of the CGA-PM algorithm is based on the NSGA-II multi-objective genetic algorithm. Hence, because of the multi-objective context, the method used to rank the individuals of the population is the dominance depth fitness assignment. Thus, the Pareto archive contains the different non-dominated solutions generated through the successive generations. Besides, the replacement process of our genetic algorithm is based on two major mechanisms: elitism and crowding. They allow respectively the evolution process to converge toward the set of non-dominated portfolios called Pareto and to maintain some diversity in the potential solutions. However, since dealing with a continuous problem, our proposed algorithm embeds some features, such as continuous variation operators, to address the problem.

The mutation operator is classical. Indeed, it chooses randomly two integers i and j such that 1≤i<j≤N, then it swaps the weights of the concerned stocks (i and j).

However, the crossover operator is more specific and works as follow. To generate the offspring s′₁, the crossover operator:
considers a portfolio s₁ as a first parent and a portfolio s₂ as a second parent,
randomly selects a β value such that 0≤β≤1,
randomly selects two integers i and j such that 0≤i<j≤n, if generating s′₁ and n≤i<j≤N if generating s′₂ where n is the number of stocks without the risk-free assets and N is the total number of assets.
copies in s all values of s₁ located between i and j, where s is a temporary variable portfolio.
applies the formula s′₁=β·s₁+(1−β)·s₂ between each couple of values of s₁ and s₂ storing the result in s′₁,
and finally copies all the values of s to the indexes of s′₁ between i and j.

A solution s′₂ is also generated by the crossover by considering s₂ as the first parent and s₁ as the second parent, and randomly selecting a new β value and applying the same previous calculations.

The constraints corresponding to equations (3) to (6) are integrated in the crossover process.

Therefore, a checking and a fixing process address the issues on the generated solutions in order to keep the solution feasible.

The checking process is applied at each step of the creation of a new portfolio via the crossover or the mutation operator, in order to respect the following constraints:
the sum of the weight of all the stocks of each portfolio must be equal to one,
the weight of a risky stock must be inferior or equal to quantity value,
the weight of a risk-free stock must be inferior or equal to quantityRFA value,
the cardinality limit,

The fixing process consists in repairing the portfolios that do not respect these constraints using an offensive mechanism or a defensive mechanism.

The offensive mechanism prevents, during the crossover, the event in which there are more stocks with a weight superior to zero than the cardinality value.

The defensive mechanism consists in equilibrating the weights of the assets in the case they exceed the quantity limit, further maintaining the sum of all the weights to one.

As previously said, the results obtained using the GA are stored in a Pareto set. Therefore, providing a unique solution (portfolio) to the user becomes difficult because of the number of solutions. To cope with this issue, it is proposed in the CGA-PM algorithm a selection step which comes right after the end of the GA execution, as illustrated in FIG. 3. The idea behind choosing a Pareto approach is to propose to the user as many efficient portfolios as possible. Each one of these portfolios is better than the other regarding a certain objective. Indeed a solution is defined with its Risk and Return.

The final portfolio selection process relies on two strategies. The first strategy gives the choice of selecting the most appropriate portfolio to the user according to its wishes. To select the most appropriate portfolio, the user should select the portfolio wherein its Return and Risk values constitute the best tradeoff for him. The parameter α is a real value set by the user. Based on the equation tradeoff value=α·Return+(1−α)·Risk, and setting the α parameter according to his needs, the user applies the formula to all the couple values (Risk, Return) of the set of portfolios of the final archive. The selected one will be the one with the highest tradeoff value according to the formula. The second strategy is called dynamic evolving mechanism. Since automated, the user does not take actions in the process. The principle of this strategy is to evolve according to the results of the previous selection policy following two steps.

The first step saves two portfolios according to two opposite strategies, one with the best Return and one with the lowest Risk. During the first iteration of CGA-PM, it starts by choosing the portfolio with the best Return (the highest Risk) and waits for the result of this portfolio during the following period. After the end of the period, it computes the Return of the non-selected portfolio (the lowest Risk) based on the known return values of the stocks after the ended period. From that moment, the selection of the next iterations depends on the results of the two portfolios (the selected and the non-selected).

If the selected portfolio obtains better results than the non-selected one, the selection will follow the same previous strategy. Otherwise, if the selected portfolio has worse results than the non-selected one, the next selected portfolio will follow the other strategy. This process is repeated every new period saving each time the opposite portfolio to the selected one in order to take the next decision. The user can interrupt the dynamic mechanism at any time in order to choose manually his portfolio.

1. A computing method for a financial portfolio management, the portfolio containing different amounts of different stocks, a stock being a set of assets, belonging to a user, characterized in which it integrates a specific mechanism for mutation and crossover operators in genetic algorithm and comprising the steps of:
representing the portfolio as a table of cells, wherein each cell contains a value of index identifying the stock and a value of weight representing the amount of investment for the concerned stock,
retrieving stock prices and user's specifications, wherein the users specifications correspond to the parameters:
a cardinality value which is the maximum number of stocks to hold in the portfolio,
a quantity value which is the maximum amount of investment allowed to be done on risky stocks,
a quantity RFA value which is the maximum amount of investment allowed to be done on a risk-free asset,
a fees value which is the fees paid by the user,
a period value which is the period after which the portfolio can evolve according to stock market changes,
computing the risk and the expected return of each stock of the portfolio,
initializing a population of a plurality of portfolios, this population being the initial solutions of the portfolio according to the parameters,
applying a fitness function which consists in computing a minimized Risk value and a maximized Return value as follow:
Maximized Return=Max(Σᵢ^{N} wᵢ·Eᵣ_{ᵢ}) where Eᵣ_{ᵢ} is the expected return value for a stock i in the portfolio, wᵢ the weight for a stock i, and N the number of stocks in the portfolio,
Minimized Risk=Min(Σⱼ^{N}((Σᵢ^{N} wᵢ·CovMatrix_{i,j}), wⱼ)), where N is the total number of stocks, wᵢ and wⱼ are the weight values (invest values) of the stock and in the portfolio, is the N×N matrix of variance and covariance values of the N dealt with stocks,
temporary storing in an archive the solutions of portfolios which have a Return superior or equal to Maximized Return and a Risk inferior or equal to Minimized Risk,
calculating a crowding distance, wherein the crowding distance is a metric defined as the circumference of a rectangle defined by the left and the right portfolios neighbors of the portfolio solution or by its unique side neighbor and the infinity in case of a single neighbor,
updating the archive by maintaining only the non-dominated portfolio with the best diversity (crowding distance), non-dominated referring to a portfolio that is not dominated in both objectives Risk and Return i.e. no portfolios in the archive has both superior Return and inferior Risk,
selecting the two portfolios parent1 and parent2 having the highest probabilities to be selected, wherein the probability pᵢ of a portfolio i to be selected is expressed as
$${p}_{i} = \frac{{f}_{i}}{{\sum }_{j = 1}^{N} {f}_{j}}$$
wherein fᵢ is the fitness function of the portfolio i, fⱼ is the fitness function of a stock j, N is the number of stock of the portfolio i,
applying a crossover operator on parent1 and parent2 or a mutation operator to parent1, and generating offspring1 and offspring2 or one offspring called offspring1, wherein:
the mutation operator chooses randomly two integers i and j such that 1≤i<j≤N, where N is the total number of stocks, and swaps the weights of the concerned stocks i and j.
the crossover operator:
considers a first and a second parent portfolio respectively s₁ and s₂,
randomly selects a β value such that 0≤β<1,
randomly selects two integers i and j such that 0≤i<j≤n, if generating s′₁ and n≤i<j≤N if generating s′₂ where n is the number of stocks without the risk-free assets and N is the total number of assets.
copies in s all values of s₁ located between i and j, where s is a temporary portfolio,
applies the formula s′₁=β·s₁+(1−β)·s₂ between each couple of values of s₁ and s₂ storing the results in s′₁, where s′₁ is the offspring portfolio,
copies all the values of s to the indexes of s′₁ between i and j.
generating offspring s′₁,
generating a second offspring s′₂ considering s₂ as the first parent and s₁ as the second parent, and applying the same previous calculations,
updating the set of portfolio solutions, according to both elitism and crowding distance, by taking each time the portfolios with the highest fitness value while looking for the highest crowding distance,
storing the solutions in a Pareto archive, comprising the steps of:
checking if the new input portfolio is not dominated by any portfolio in the archive,
adding the new portfolio to the archive if there is no dominating portfolio,
keeping the portfolio with the largest crowding distance if two portfolios have the same Return and the same Risk,
deleting any dominated portfolio from the archive
returning a set of non-dominated portfolios,
selecting one portfolio in the archive according to a chosen policy,
returning this portfolio to the user,
initiating a new cycle comprising the steps from the retrieving stock prices and user's specifications to this one, according to a period of time called period.

2. A computing method according to claim 1, wherein the initialized population comprises at least 100 portfolios.

3. A computing method according to claim 1, wherein the encoding step has a step of assigning a value 0 to the weights of the stocks exceeding the cardinality limit.

4. A computing method according to claim 1, wherein the initializing step comprises the steps of:
generating random weight values according to cardinality and quantity parameters,
checking at each step of the creation of a new portfolio via the crossover or the mutation operator, the following constraints in the initialized portfolios:
the sum of the weight of all the stocks of each portfolio must be equal to one,
the weight of a risky stock must be inferior or equal to quantity value,
the weight of a risk-free asset must be inferior or equal to quantityRFA value,
the cardinality limit,
fixing the portfolios that do not respect these constraints using
an offensive mechanism which consists in preventing, during the crossover, the event in which there is more actions with a weight superior to zero than the cardinality value,
or a defensive mechanism which consists in equilibrating the weights of the assets in the case they exceed the quantity limit while maintaining the sum of all the weights to one.

5. A computing method according to claim 4, wherein the random weight values generating step is provided by:
generating a number of values, bigger than 0 and smaller than quantity in a number equals to cardinality value,
randomly assigning those values to the different stocks.

6. A computing method according to claim 1, wherein the determination of the expected return of a stock comprises the steps of:
retrieving a matrix of the historical returns of the stocks,
computing, from the matrix of historical returns, a variance covariance matrix of all the stocks,
retrieving the values of the Moving Average Convergence Divergence Method (MACD) and the Average Index Indicator (ADX) indicator, which are two stock market indicators,
computing the product of the absolute values of both ADX and MACD,
assigning the value of this product to the absolute value of the expected return,
assigning a negative sign to the expected return if both MACD and ADX indicators agree on a decreasing trend and positive otherwise.
